(19) United States
(12) Patent Application Publication
(10) Pub. No.: US 2026/0311191 A1
(43) Pub. Date: Oct. 8, 2026

(54) ELECTRICAL SERVICE TYPE CLASSIFICATION

(71) Applicant: Itron, Inc., Liberty Lake, WA (US)

(72) Inventors: Gokulmuthu Narayanaswamy, Bangalore (IN); Gopakumar Gopinathan, Granite Bay, CA (US); Aditya Kumar Gupta, Raigarh (IN); Raj Bhula, San Jose, CA (US)

(21) Appl. No.: 19/169,903

(22) Filed: Apr. 3, 2025

(51) Int. Cl. G06Q 30/016; G06Q 50/06; H02J 3/00; H02J 3/14; H02J 3/38; H02J 13/00

(52) U.S. Cl. CPC G06Q 30/016; G06Q 50/06; H02J 3/003; H02J 3/14; H02J 3/38; H02J 13/12; H02J 2101/24

(57) ABSTRACT

Techniques for electrical service type classification are described herein. In some instances, electric utility companies will classify customers as residential, commercial, industrial, hospitality, agricultural, etc. The classifications may be used to determine the price of electricity for a number of social purposes. Additionally, the classifications are used to better understand and predict load levels and load timing. The classifications can also be used to predict the growth of load over time within areas served by generating facilities, substations, high and medium voltage transmission lines, and by individual transformers. The classifications may also be used to make better long-term choices (e.g., power plant construction) and short-term choices (e.g., a level of spinning reserve). The classifications may also be used to balance loads between transformers, to assist in the prediction of electricity loads, and to make any number of modifications to improve an electricity grid.

### BACKGROUND

In the electrical utility industry, customer service sites include various customer types, including residential, commercial, industrial, public service, agricultural, etc. Such service sites may be incorrectly or inaccurately classified.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components. Moreover, the figures are intended to illustrate general concepts, and not to indicate required and/or necessary elements.

FIG. 1 is a block diagram showing portions of an electricity grid, including a system for customer service type classification.

FIG. 2 is a block diagram showing an example implementation of the system for customer service type classification.

FIG. 3 is a graph showing an example of power consumption during a weekday at a customer service site wherein the customer is correctly classified as residential.

FIG. 4 is a graph showing an example of power consumption during the weekend at a customer service site wherein the customer is correctly classified as residential.

FIG. 5 is a graph showing an example of power consumption at a customer service site wherein the customer is correctly classified as a restaurant.

FIG. 6 is a graph showing an example of power consumption at a customer service site wherein the customer is correctly classified as industrial.

FIG. 7 is a graph showing an example of power consumption at a customer service site wherein the customer is classified as a suspected grow house (e.g., a criminal enterprise).

FIG. 8 is a flow diagram showing example techniques of a system for electrical service type classification and increased electricity grid efficiency.

FIG. 9 is a flow diagram showing two example techniques for using load data to determine a classification of a customer service site.

FIG. 10 is a flow diagram showing third example techniques for using load data to determine a classification of a customer service site.

FIG. 11 is a flow diagram showing example techniques for adjusting operation of the electricity grid responsive to customer classifications.

FIG. 12 is a flow diagram showing optional example techniques for use with a system for electrical service type classification and increased electricity grid efficiency.

FIG. 13 is a flow diagram showing optional example techniques for use with a system for electrical service type classification and increased electricity grid efficiency.

### DETAILED DESCRIPTION

### Electricity Grid Management Using Customer Classifications

Techniques for electrical service type classification and increased electricity grid efficiency are described herein. Using the techniques, electric utility companies classify customers as residential, commercial, industrial, hospitality, governmental, agricultural, etc.

The classifications may be used to determine the price of electricity for a number of social purposes. Additionally, the classifications are used to better understand and predict load levels, locations (e.g., at the substation and/or transformer level) of load levels, and load-change timing. The classifications can also be used to predict the growth of load over time within areas served by generating facilities, substations, high and medium voltage transmission lines, and by individual transformers. The classifications may also be used to make better long-term choices (e.g., power plant construction) and short-term choices (e.g., a level of spinning reserve). The classifications may also be used to determine a priority for service in times of power shortages. The classifications may also be used to balance loads between transformers, to assist in the prediction of electricity loads, to respond proactively to those predictions, such as by: adjustment to a level of spinning reserve; by moving a customer to a different transformer; by adding new transformers to a medium-voltage line; by adding new high-and/or medium-voltage lines; and/or to make any number or combinations of other modifications to an electricity grid.

In some examples, a customer service site may be classified according to a hybrid of service types. Alternatively or additionally, it is possible to assign multiple service types to a single customer service site. The process of customer service site type classification may be performed at intervals, so that the service type can be tracked over time. Such tracking allows the customer and/or utility company to know the service type classification(s) both historically and at present. Changes in load pattern and/or service type classification are useful indications of anomaly detection (fraud detection) and for other electricity grid management functions.

Customer service sites may be wrongly classified, either accidentally or willfully (e.g., due to deceit or misrepresentation of the customer). Detecting and correcting such misclassifications will aid in providing: a stronger and more resilient electricity grid; less overloading of transformers, medium-voltage lines, and substations, etc. ; a better understanding of electricity demand over time and forecasts for future electrical demand and consumption; and more efficient use of spinning reserve; etc.

### Example Systems and Techniques

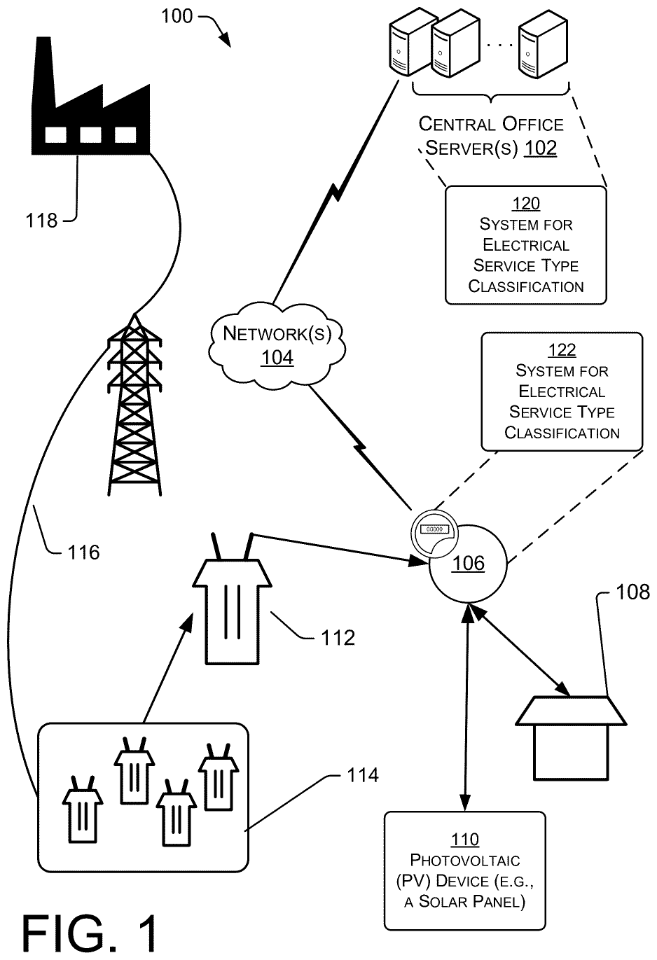

FIG. 1 shows an example electricity grid 100 and example implementation of a system, devices, methods, and associated techniques for electrical service type classification and electrical grid improvements based on more accurate electrical service type classifications. The example electricity grid 100 shows that the techniques for electrical service type classification and increase electricity grid efficiency may implemented: by operation of the smart electricity meters; and/or by operation a server at the electricity company and/or “cloud” level. In some examples, some functions and techniques may be performed at the smart electricity meter and other functions and techniques may be performed by a server, cloud computing devices and/or cloud computing facility, and/or other networked computing device.

The example electricity grid 100 includes central office server(s) 102 (e.g., computers) and network(s) 104. The central office server(s) 102 may be servers at an electricity utility company, servers at a cloud computing center, or other computing devices. The communications network(s) 104 may include one or more of the internet, proprietary utility company network(s) using radio, powerline communications (PLC), mesh networks, star networks, combinations of any or all of these, etc.

A smart electricity meter 106 serves a customer service site 108, and is representative of many such meters and customer service sites, which may number in the thousands or hundreds of thousands. In the example shown, the meter is a smart meter and is in communication with the central office server(s) 102 through the network(s) 104.

A photovoltaic (PV) device 110 (e.g., a solar panel) is configured to provide power to the customer service site 108, and is representative of other types of distributed electricity generation, including wind, geothermal, etc. Similarly, electricity storage devices, such as batteries and electric vehicles (EVs) can be charged at the customer service site 108. Such devices, including those that produce electricity such as solar panels, and those that consume electricity such as EVs, can be used to assist in the determination of a type of the service site. In some installations, the smart electricity meter 106 may meter power (and/or measure energy) created by the PV device 110 and used on the customer service site 108. In such installations, the customer is billed for less electrical energy than is used by the customer. In some installations, the smart electricity meter 106 may meter power created by the PV device 110 when the power is sent to the electricity grid. In such installations, the customer may receive payment for the power.

The smart electricity meter may be connected to a transformer 112 from among a plurality of transformers 114 supplied by a medium-voltage line 116 and power generating and/or substation facility 118.

All or parts of the system for electrical service type classification and increase electricity grid efficiency may be located on the central office server(s) 102, or on the smart electricity meter 106. For purposes of illustration, FIG. 1 shows three examples, wherein: the system 120 performs the functionality and is located on the central office server(s) 102; the system 122 performs the functionality and is located on the smart electricity meter 106; and a bifurcated or compound device or system wherein the system 120 includes some of the functionality, while the system 122 includes the remainder of the functionality, which may or may not be overlapping. In a configuration wherein the system 120 is utilized the control and processing is more centralized; in contrast, a configuration wherein a plurality of systems 122 are associated with respective smart electricity devices across the power grid, the processing and control functions are more distributed.

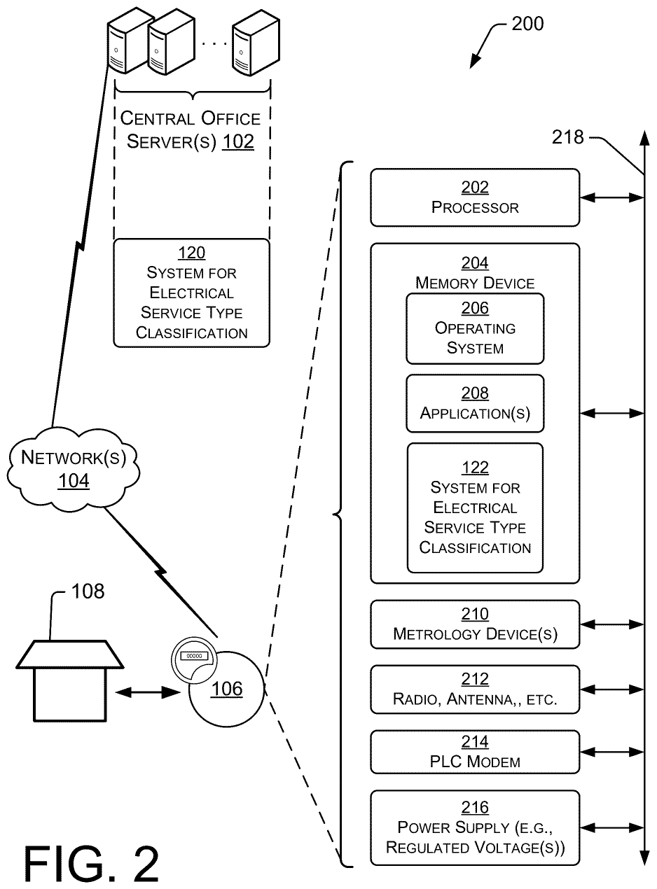

FIG. 2 shows an example implementation 200 of the system for electrical service type classification. In the example shown, the smart electricity meter 106 includes a processor 202 and memory device 204. The memory device 204 may include software programs that are processor-executable and/or computer-executable, and that when executed by the processor 202, perform useful functions. In the example of FIG. 2, software applications are shown, including an operating system 206 and application(s) 208.

The smart electricity meter 106 may include metrology device(s) 210, which measures the consumption of electricity (and optionally, the production of electricity by a PV device). The smart electricity meter 106 may include a radio 212 and antenna. Alternatively or additionally, the smart meter may include a PLC modem 214 or other communications device. The smart electricity meter 106 may also include a power supply 216, which may be configured to provide voltage-regulated direct current (DC) power at one or more prescribed voltage levels for operation of the processor 202, the memory device 204, the metrology device(s) 210, the radio 212, and/or other devices. A bus, printed circuit board, wiring harness, and/or other circuit connectivity device(s) 218 may be used to connect the processor 202, the memory device 204, the metrology devices 210, the radio 212, and the power supply 216, etc.

Either, or both, of the system 120 and the system 122 for electrical service type classification may be present, depending on the design of the implementation 200.

### Example Power Consumption Associated with Customer Classifications

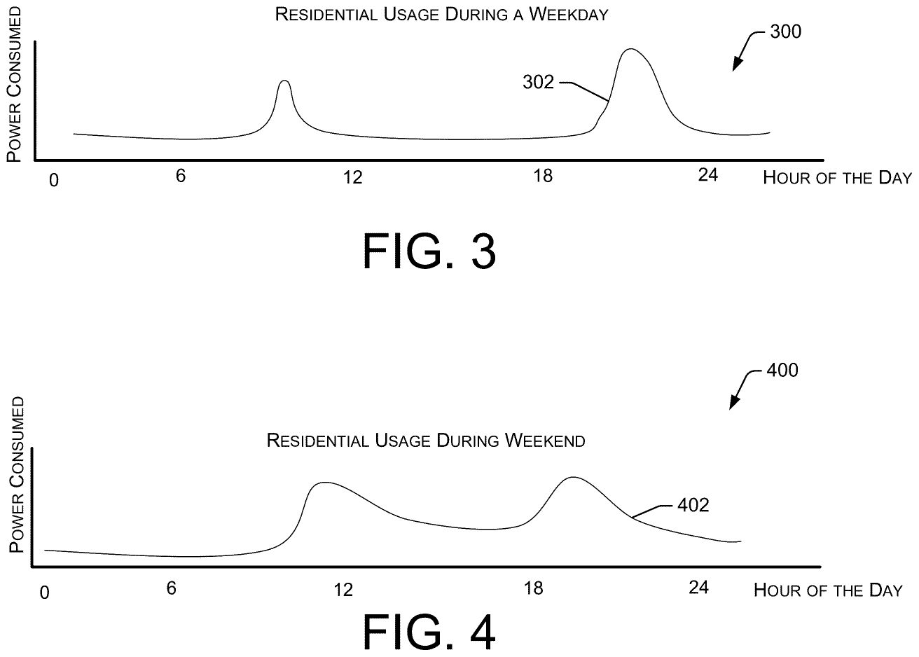

FIGS. 3 through 7 are representative of customer classification types. The classification types may be characterized by power usage over time, overall energy usage, voltages used (e.g., 120-volt, 240-volt, 3-phase, etc.) and/or other factors. In an example, an algorithm, neural network, artificial intelligence (AI), or software executable could use data from, or characteristics of, the examples 300, 400, 500, 600, 700 (as full or partial input) to a classification system. Accordingly, customer service sites can be assigned or reassigned to a correct classification type. While the examples 300-700 are presented, other examples are easily envisioned and could be used. For example, power usage over time can be determined for government offices, banks, office buildings, etc., and used in further classification processes. Accordingly, considerable understanding of the electricity consumption habits electricity customers can be obtained, and subsequently used for service site classification to increase electricity grid reliability, to control costs, to promotes safety, etc.

FIG. 3 shows first example data 300 of customer classification. The example 300 shows power consumption 302 during a weekday at a customer service site wherein the customer is correctly classified as a residential customer. The curve 302 shows power used over time, while the area under the curve shows energy used.

FIG. 4 shows second example data 400 of customer classification. The example data 400 shows power consumption 402 during a weekend at a customer service site wherein the customer is correctly classified as a residential customer.

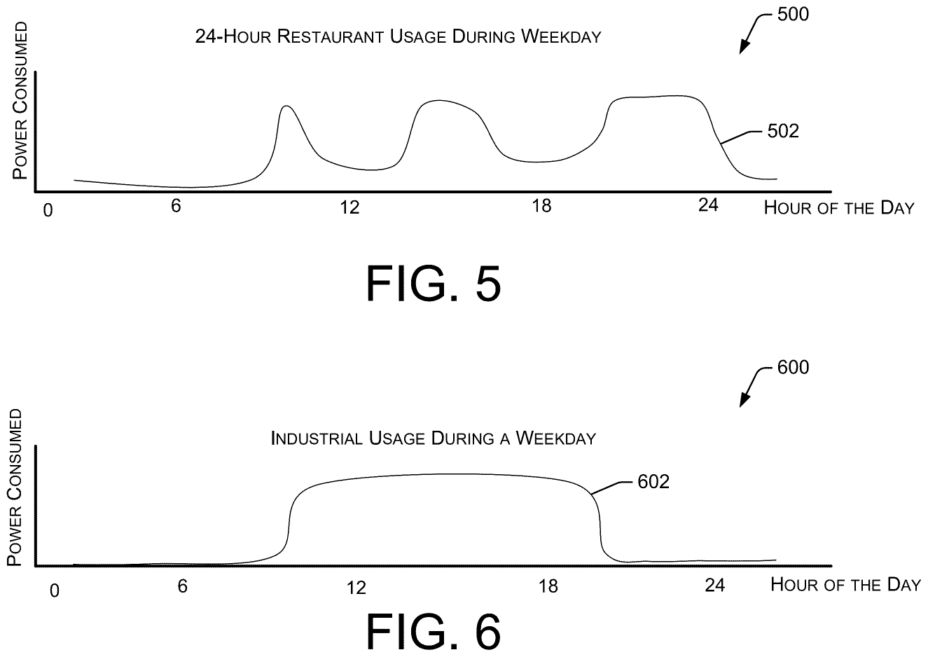

FIG. 5 shows third example data 500 of customer classification. The example data 500 shows power consumption 502 during a weekday at a customer service site wherein the customer is correctly classified as a 24-hour restaurant.

FIG. 6 shows a fourth example data 600 of customer classification. The example data 600 shows power consumption 602 during a weekday at a customer service site wherein the customer is correctly classified as industrial.

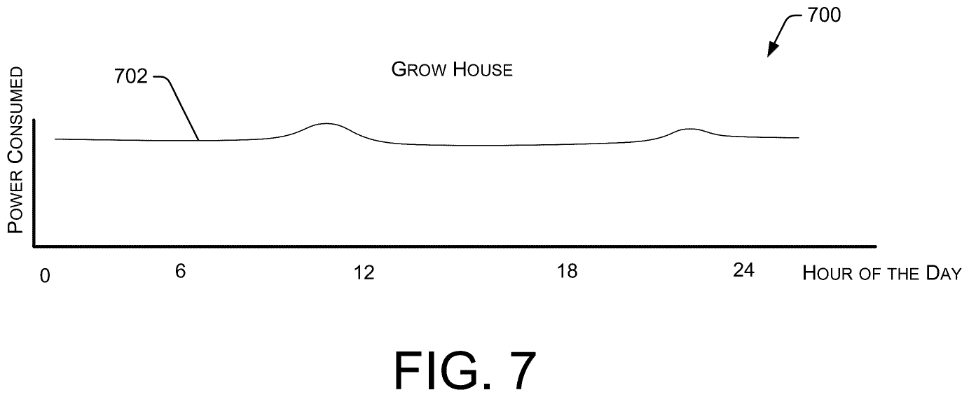

FIG. 7 shows a fifth example data 700 of customer classification. The example data 700 shows power consumption 702 at a customer service site wherein the customer is correctly classified as a grow house (i.e., a criminal enterprise) or alternatively, a bit coin mining operation.

### Example Methods of Operation

In some examples, the techniques discussed herein may be implemented by one more processors accessing software defined on one or more memory devices. The processor(s) and memory device(s) may be located on a smart utility meter and/or a cloud-based server (e.g., a server of a utility company). If the functionality is distributed, portions of the software may reside on each of the smart utility meter and the server.

In other examples of the techniques discussed herein, the methods of operation may be performed by one or more application specific integrated circuits (ASIC) or may be performed by a general-purpose processor utilizing software comprising statements defined in computer readable media. In the examples and techniques discussed herein, the memory device 204 may comprise computer-readable media and may take the form of volatile memory, such as random-access memory (RAM) and/or non-volatile memory, such as read only memory (ROM) or flash RAM. Computer-readable media devices include volatile and non-volatile, removable, and non-removable media implemented in any method or technology for storage of information such as computer-readable instructions, data structures, program modules, or other data for execution by one or more processors of a computing device. Examples of computer-readable media include, but are not limited to, phase-change memory (PRAM), static random-access memory (SRAM), dynamic random-access memory (DRAM), other types of random access memory (RAM), read-only memory (ROM), electrically erasable programmable read-only memory (EEPROM), programmable read-only memory (PROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transitory medium that can be used to store information for access by a computing device.

As defined herein, computer-readable media includes non-transitory media. Computer-readable media does not include transitory media, such as modulated data signals and carrier waves, and/or other information-containing signals.

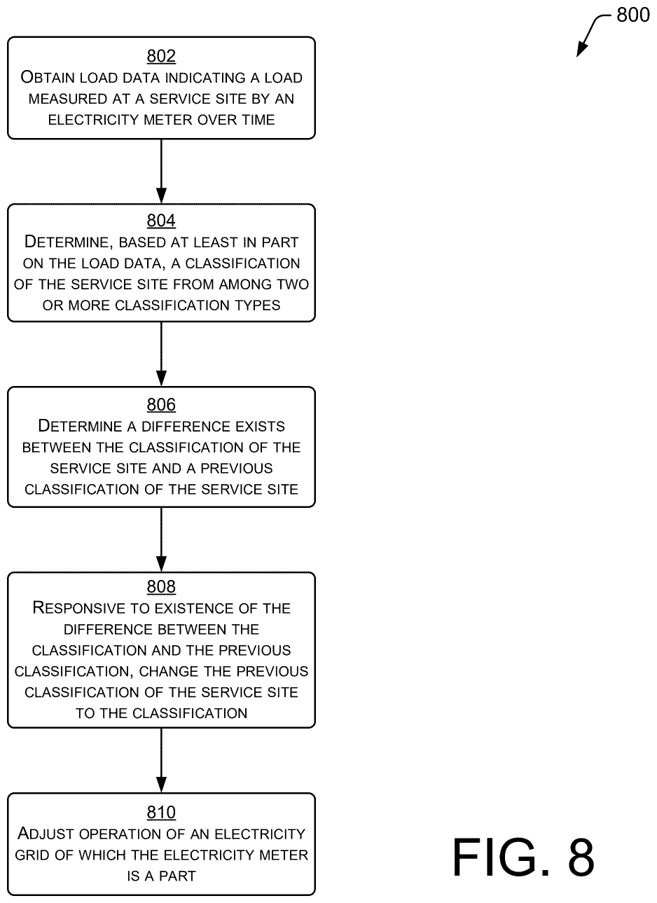

FIG. 8 shows an example method 800 and techniques of operation of a system for electrical service type classification and increased electricity grid efficiency. At block 802, load data is obtained, wherein the load data indicates a load measured at a customer service site by an electricity meter over time.

At block 804, a classification is determined. The determination may be based at least in part on the load data, which may be compared to data defining or representing classifications of the customer service site(s) from among two or more classification types. FIGS. 3-7 show examples of such data, i.e., data defining customer service classification types. In the example of FIGS. 1 and 2, one or both of the system 120 and the system 122 may use an algorithm, neural network, artificial intelligence (AI), or software executable, and may use data from, or characteristics of, the examples 300, 400, 500, 600, 700 to classify or reclassify a type of customer. The examples 300 through 700 are meant to be representative, and not exhaustive, of classification data usable by the system 120 and/or the system 122.

At block 806, a difference between the classification of the customer service site and a previous classification of the customer service site may be determined. (Or the existence of a difference is determined.) Thus in block 806, the classification determined at block 804 is found to be different than the previously assigned classification. In the example of FIGS. 1 and 2, the may be determined by operation of the system 120 and/or the system 122.

At block 808, responsive to existence of the difference (found at block 806) between the classification of the customer service site and the previous classification, the previous classification of the customer service site is changed to the classification determined at block 804.

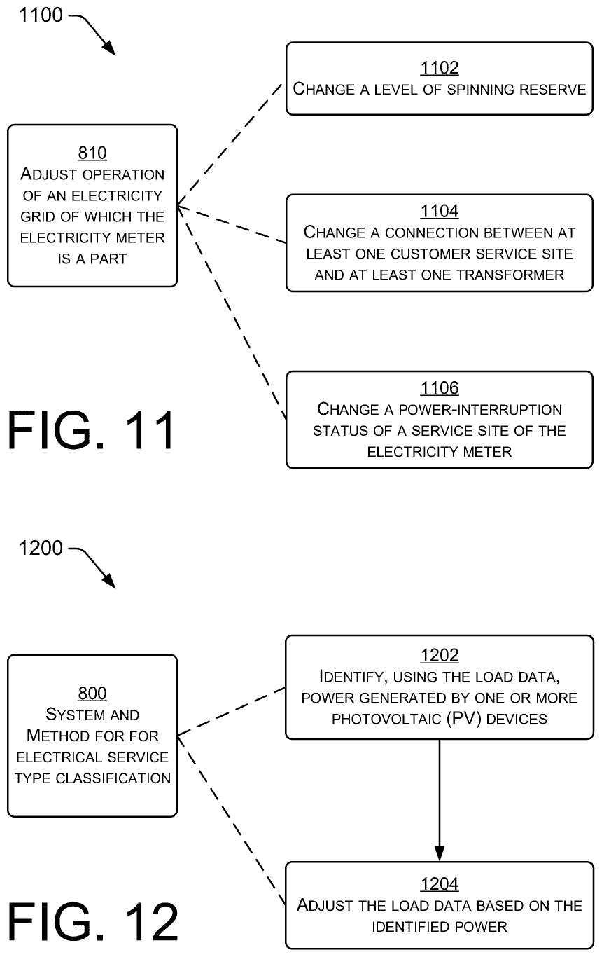

At block 810, operation of an electricity grid (of which the electricity meter is a part) is adjusted. Example adjustments are seen in FIG. 11.

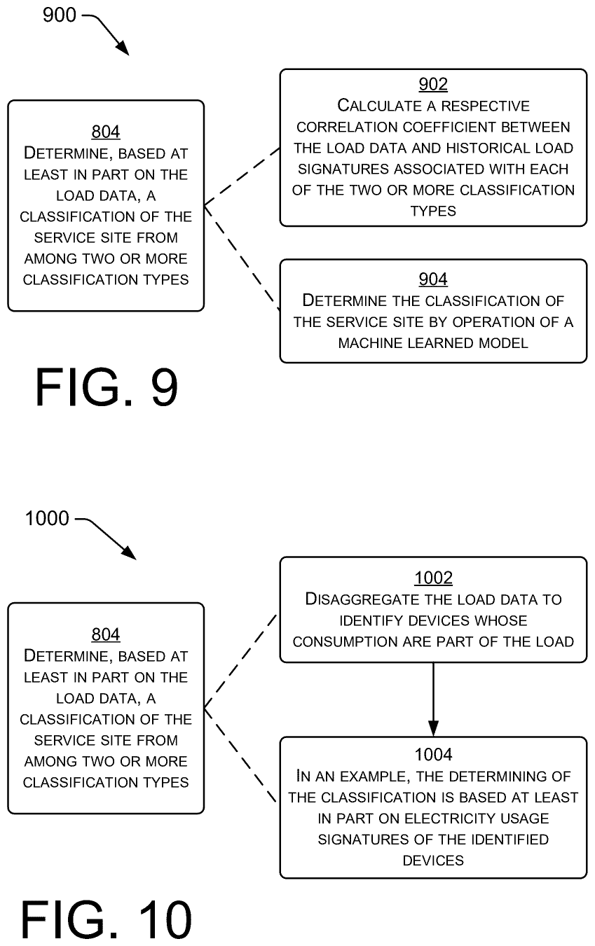

FIG. 9 shows two example methods 900 and techniques for using load data to determine a classification of a customer service site. Accordingly, methods 900 include two possible implementations of block 804 of FIG. 8, wherein a classification of a customer service site is determined. In the example of block 902, correlation coefficients—between the load data and historical load signatures associated with each of the two or more classification types—is calculated. The calculation produces correlation coefficients which can be compared, and a best fit determined between the load data of the customer service site and the load data associated with classification types (e.g., the load data of FIGS. 3-7). In an example, load data associated with known and trusted historical load signatures representing particular customer classification types may be compared to the load data of a customer service site. If the comparison indicates a close correlation, then the customer classification type associated with the close correlation may be assigned to the customer service site. The correlation between a customer classification type and the load data of a customer service site can be based on a statistical correlation. There are several ways of calculating correlation and similarity of one load data pattern (e.g., a customer classification type) to another load data pattern (e.g., actual customer load data). In an example, a ‘Dynamic Time Warping’ distance may be used as a way to quantify the match of two given load patterns. The lower the distance (closer to 0), the better match it is. Alternative algorithms may also be used, depending on design goals, costs, the characteristics of a particular system, etc.

In the example of block 904, the classification of the service site may be determined by operation of a machine learning model, an AI process, or other pattern recognition system. In an example, a machine learning model may be trained for the purpose of classifying a load. Such a model may utilize hundreds and/or thousands of labeled premises (i.e., customer service sites having a customer classification type) wherein the veracity can be verified, determined and/or confirmed. Historical load from each of the premises can be read and summarized in a way that can be used by various machine learning/deep learning models. This step is called featurization. After a dataset is labeled with the classifications, a model can be trained using the dataset. Once trained, the machine learning model can be validated using another part of data that the model has not seen. Ultimately, the model will be tested on new and unseen data, resulting in a real-world validation.

FIG. 10 shows an example method 1000 and techniques for determining a classification of a service site. Accordingly, method 1000 is a further possible implementations of block 804 of FIG. 8, wherein a classification of a customer service site is determined. In the example of block 1002, the load data from a customer service site is disaggregated to identify devices whose consumption are part of the load. In the example of block 1004, the determining of the classification of the customer service site is based at least in part on electricity usage signatures of the identified devices. In examples, if the disaggregation reveals the use of home appliances, this may indicate a residential classification type. If disaggregation reveals the use of industrial machinery, large HVAC systems, agricultural pumping equipment, etc., then the disaggregation would indicate industrial classification, commercial classification, agricultural classification etc.

FIG. 11 shows techniques for adjusting operation of the electricity grid responsive to customer classifications. Accordingly, method 1100 provides variations and example implementations of block 810 of FIG. 8, wherein operation of an electricity grid adjusted to increase grid efficiency, grid safety, the stress (e.g., overloading) of grid components, etc. The elements of method 1100 may be performed singly, in combinations including two or all of the elements. Additionally, the elements of the method 1100 may be combined with, or substituted by, elements discussed infra and supra. In the example of block 1102, a level of a spinning reserve of the electricity grid is changed. In an example, if a group of customer service sites that were previously thought to be residences are discovered to be small shops, the weekday load may be higher than anticipated and the level of spinning reserve may need to be increased. Or, if a number of customer sites claimed to be agricultural in nature, but were actually commercial, spinning reserve thought to be needed for pumping water during certain seasons may not be needed. In the example of block 1104, a connection between at least one customer site and at least one transformer is changed. In an example, if changes in customer service site classification type reveal that residential customers were actually commercial businesses, it may be necessary to reassign the customers to different (existing and/or newly installed) transformers to prevent transformer overloading. In the example of block 1106, a power-interruption status of a service site may need to be changed. In an example, if a residential customer service site was previously classified as a doctor's office (to benefit from a better power-interruption status), then a change in the customer service site classification type may allow greater flexibility of the electricity grid during periods of insufficient generating capacity.

FIG. 12 shows additional example method(s) 1200 and techniques for use with a system for electrical service type classification and increased electricity grid efficiency. Accordingly, method 1200 describes further possible steps, actions, and/or techniques that may optionally be combined with some or all of the method 800 of FIG. 8. In the example of block 1202, power generated by one or more photovoltaic (PV) devices is identified, based at least in part on the load data. In an example, if power measured by the smart metering device is correlated to conditions associated with PV power production, then a level of power production (and/or energy over time) can be estimated and/or measured. In the example of block 1204, the load data is adjusted based on the identified power. By adjusting the load data, and thereby having adjusted data, the determination of the classification type of the customer service site of block 804 of FIG. 8 may be more accurately performed. Thus, if PV power and/or energy generation is identified, then that generation is added to the measured consumption from the grid when performing the classification process (e.g., block 804 of FIG. 8).

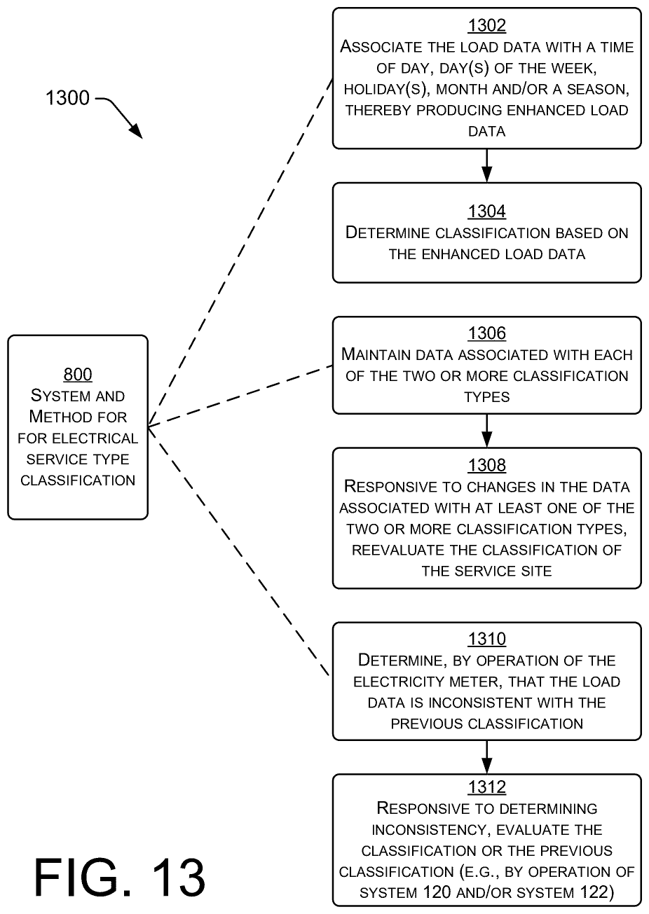

FIG. 13 shows additional example method(s) 1300 and techniques for use with a system for electrical service type classification and increased electricity grid efficiency. Accordingly, method 1300 describes further possible steps, actions, and/or techniques that may optionally be combined with some or all of the method 800 of FIG. 8. At block 1302, the load data is associated with: a time of day; day(s) of the week; holiday(s); a month; and/or a season, thereby producing enhanced load data. In the example of block 1304, the determining of the classification (e.g., block 804 of FIG. 8) is based on the enhanced load data.

At block 1306, data associated with each of the two or more classification types is maintained. At block 1308, responsive to changes in the data associated with at least one of the two or more classification types, the classification of the service site is reevaluated. That is, the characteristics of one or more classification types may change over time. Typical store hours may change, people may work from home more, industries may use even more heavy equipment, electric vehicles may become more popular, etc. Thus, by maintaining information about correctly classified customer service sites, the changes in typical loads may become significant. Accordingly, when customer service sites require reevaluation and reassignment of classification type, the revised and maintained data is used.

At block 1310, it is determined (e.g., by operation of the electricity meter, system 120 and/or system 122) that the load data is inconsistent with the previous classification. At block 1312, responsive to determining inconsistency, the classification or the previous classification is evaluated or reevaluated (e.g., by operation system 120 and/or system 122 of FIGS. 1 and 2).

### Example Systems, Devices, Methods, and Techniques

The following examples of solar panel efficiency detection based on generation patterns are expressed as lettered clauses. While the examples illustrate a number of possible configurations and techniques, they are not meant to be an exhaustive listing of the systems, methods, and/or techniques described herein.

A. A method, comprising: obtaining load data indicating a load measured at a customer service site by an electricity meter over time; determining, based at least in part on the load data, a classification of the customer service site from among two or more classification types; determining a difference exists between the classification of the customer service site and a previous classification of the customer service site; and responsive to existence of the difference between the classification and the previous classification, changing the previous classification of the customer service site to the classification.

B. The method of clause A, wherein determining the classification of the customer service site from among the two or more classification types comprises: calculating respective correlation coefficients between the load data and historical load signatures associated with each of the two or more classification types.

C. The method of clause A, wherein determining the classification of the customer service site is performed by a machine learned model.

D. The method of clause A, additionally comprising: disaggregating the load data to identify devices whose consumption is part of the load, wherein determining the classification is based at least in part on electricity usage signatures of the identified devices.

E. The method of clause A, additionally comprising: adjusting operation of a component an electricity grid of which the electricity meter is a part, wherein the adjusting is based at least in part on changing the electricity meter from the previous classification to the classification, and wherein the adjusting comprises at least one of: changing a level of spinning reserve; changing a connection between at least one customer service site and at least one transformer; and changing a power-interruption status of the customer service site of the electricity meter.

F. The method of clause A, additionally comprising: identifying, using the load data, power generated by one or more photovoltaic (PV) devices; and adjusting the load data based on the identified power.

G. The method of clause A, additionally comprising: associating the load data with a time of day, day(s) of the week, holiday(s), a month, and/or a season, thereby producing enhanced load data, wherein determining the classification is based on the enhanced load data.

H. The method of clause A, additionally comprising: maintaining data associated with each of the two or more classification types; and responsive to changes in the data associated with at least one of the two or more classification types, reevaluating the classification of the customer service site.

I. The method of clause A, additionally comprising: determining, by operation of the electricity meter, that the load data is inconsistent with the previous classification; and responsive to determining inconsistency, evaluating the classification or the previous classification.

J. The method of clause A, wherein the method is performed by at least one of: the electricity meter; or a computer.

The method as recited above, additionally comprising one or more of, or any combination of, or all of, the preceding clauses.

K. A device, comprising: a processor; one or more memory devices in communication with the processor; and statements, defined in the one or more memory devices, which when executed by the processor to perform actions comprising: obtaining load data indicating a load measured at a customer service site by an electricity meter over time; determining, based at least in part on the load data, a classification of the customer service site from among two or more classification types; determining a difference exists between the classification of the customer service site and a previous classification of the customer service site; responsive to existence of the difference between the classification and the previous classification, changing the previous classification of the customer service site to the classification; and adjusting operation of a component an electricity grid of which the electricity meter is a part.

L. The device as recited in clause K, the adjusting comprises at least one of: changing a level of spinning reserve; changing a connection between at least one customer service site and at least one transformer; and changing a power-interruption status of the customer service site of the electricity meter.

M. The device as recited in clause K, wherein the actions additionally comprise: disaggregating the load data to identify devices whose consumption are part of the load, wherein determining the classification is based at least in part on electricity usage signatures of the identified devices.

N. The device as recited in clause K, wherein the actions additionally comprise: identifying, using the load data, power generated by one or more photovoltaic (PV) devices; and adjusting the load data based on the identified power.

O. The device as recited in clause K, wherein determining the classification of the customer service site from among the two or more classification types comprises: calculating a respective correlation coefficient between the load data and historical load signatures associated with each of the two or more classification types.

The device as recited above, additionally comprising one or more of, or any combination of, or all of, the preceding clauses.

P. One or more non-transitory computer-readable media storing computer-executable instructions that, when executed by one or more processors, configure a computing device to perform actions comprising: obtaining load data indicating a load measured at a customer service site by an electricity meter over time; determining, based at least in part on the load data, a classification of the customer service site from among two or more classification types; determining a difference exists between the classification of the customer service site and a previous classification of the customer service site; and responsive to existence of the difference between the classification and the previous classification, changing the previous classification of the customer service site to the classification.

Q. One or more computer-readable media as recited in clause P, wherein the actions additionally comprise: adjusting operation of a component an electricity grid of which the electricity meter is a part, wherein the adjusting is based at least in part on changing the electricity meter from the previous classification to the classification, and wherein the adjusting comprises at least one of: changing a level of spinning reserve; changing a connection between at least one customer service site and at least one transformer; and changing a power-interruption status of the customer service site of the electricity meter.

R. One or more computer-readable media as recited in clause P, wherein the actions additionally comprise: disaggregating the load data to identify devices whose consumption are part of the load, wherein determining the classification is based at least in part on electricity usage signatures of the identified devices.

S. One or more computer-readable media as recited in clause P, wherein the actions additionally comprise: identifying, using the load data, power generated by one or more photovoltaic (PV) devices; and adjusting the load data based on the identified power.

T. One or more computer-readable media as recited in clause P, wherein the actions additionally comprise: calculating a respective correlation coefficient between the load data and historical load signatures associated with each of the two or more classification types.

The one or more computer-readable media as recited above, additionally comprising one or more of, or any combination of, or all of, the preceding clauses.

### Conclusion

Although the subject matter has been described in language specific to structural features and/or methodological actions, it is to be understood that the subject matter defined in the appended claims is not necessarily limited to the specific features or actions described. Rather, the specific features and actions are disclosed as exemplary forms of implementing the claims.

The words comprise, comprises, and/or comprising, when used in this specification and/or claims do not preclude the presence or addition of one or more other features, devices, techniques, and/or components and/or groups thereof.

1. A method, comprising:
obtaining load data indicating a load measured at a customer service site by an electricity meter over time;
determining, based at least in part on the load data, a classification of the customer service site from among two or more classification types;
determining a difference exists between the classification of the customer service site and a previous classification of the customer service site;
responsive to existence of the difference between the classification and the previous classification, changing the previous classification of the customer service site to the classification; and
adjusting operation of a component of an electricity grid of which the electricity meter is a part.

2. The method of claim 1, wherein determining the classification of the customer service site from among the two or more classification types comprises:
calculating respective correlation coefficients between the load data and historical load signatures associated with each of the two or more classification types.

3. The method of claim 1, wherein determining the classification of the customer service site is performed by a machine learned model.

4. The method of claim 1, additionally comprising:
disaggregating the load data to identify devices whose consumption is part of the load,
wherein determining the classification is based at least in part on electricity usage signatures of the identified devices.

5. The method of claim 1, additionally comprising:
wherein the adjusting is based at least in part on changing the electricity meter from the previous classification to the classification, and wherein the adjusting comprises at least one of:
changing a level of spinning reserve;
changing a connection between at least one customer service site and at least one transformer; and
changing a power-interruption status of the customer service site of the electricity meter.

6. The method of claim 1, additionally comprising:
identifying, using the load data, power generated by one or more photovoltaic (PV) devices; and
adjusting the load data based on the identified power.

7. The method of claim 1, additionally comprising:
associating the load data with a time of day, day(s) of the week, holiday(s), a month, and/or a season, thereby producing enhanced load data,
wherein determining the classification is based on the enhanced load data.

8. The method of claim 1, additionally comprising:
maintaining data associated with each of the two or more classification types; and
responsive to changes in the data associated with at least one of the two or more classification types, reevaluating the classification of the customer service site.

9. The method of claim 1, additionally comprising:
determining, by operation of the electricity meter, that the load data is inconsistent with the previous classification; and
responsive to determining inconsistency, evaluating the classification or the previous classification.

10. The method of claim 1, wherein the method is performed by at least one of:
the electricity meter; or
a computer.

11. A device, comprising:
a processor;
one or more memory devices in communication with the processor; and
statements, defined in the one or more memory devices, which when executed by the processor to perform actions comprising:
obtaining load data indicating a load measured at a customer service site by an electricity meter over time;
determining, based at least in part on the load data, a classification of the customer service site from among two or more classification types;
determining a difference exists between the classification of the customer service site and a previous classification of the customer service site;
responsive to existence of the difference between the classification and the previous classification, changing the previous classification of the customer service site to the classification; and
adjusting operation of a component of an electricity grid of which the electricity meter is a part.

12. The device as recited in claim 11, the adjusting comprises at least one of:
changing a level of spinning reserve;
changing a connection between at least one customer service site and at least one transformer; and
changing a power-interruption status of the customer service site of the electricity meter.

13. The device as recited in claim 11, wherein the actions additionally comprise:
disaggregating the load data to identify devices whose consumption are part of the load,
wherein determining the classification is based at least in part on electricity usage signatures of the identified devices.

14. The device as recited in claim 11, wherein the actions additionally comprise:
identifying, using the load data, power generated by one or more photovoltaic (PV) devices; and
adjusting the load data based on the identified power.

15. The device as recited in claim 11, wherein determining the classification of the customer service site from among the two or more classification types comprises:
calculating a respective correlation coefficient between the load data and historical load signatures associated with each of the two or more classification types.

16. One or more non-transitory computer-readable media storing computer-executable instructions that, when executed by one or more processors, configure a computing device to perform actions comprising:
obtaining load data indicating a load measured at a customer service site by an electricity meter over time;
determining, based at least in part on the load data, a classification of the customer service site from among two or more classification types;
determining a difference exists between the classification of the customer service site and a previous classification of the customer service site;
responsive to the existence of the difference between the classification and the previous classification, changing the previous classification of the customer service site to the classification; and
adjusting operation of a component of an electricity grid of which the electricity meter is a part.

17. One or more non-transitory computer-readable media as recited in claim 16, wherein the actions additionally comprise:
part, wherein the adjusting is based at least in part on changing the electricity meter from the previous classification to the classification, and wherein the adjusting comprises at least one of:
changing a level of spinning reserve;
changing a connection between at least one customer service site and at least one transformer; and
changing a power-interruption status of the customer service site of the electricity meter.

18. One or more non-transitory computer-readable media as recited in claim 16, wherein the actions additionally comprise:
disaggregating the load data to identify devices whose consumption are part of the load,
wherein determining the classification is based at least in part on electricity usage signatures of the identified devices.

19. One or more non-transitory computer-readable media as recited in claim 16, wherein the actions additionally comprise:
identifying, using the load data, power generated by one or more photovoltaic (PV) devices; and
adjusting the load data based on the identified power.

20. One or more non-transitory computer-readable media as recited in claim 16, wherein the actions additionally comprise:
calculating a respective correlation coefficient between the load data and historical load signatures associated with each of the two or more classification types.

21. The method of claim 1, wherein determining the difference between the classification and the previous classification comprises detecting an anomaly indicative of fraud at the customer service site.

22. The method of claim 1, further comprising:
performing the determining of the classification at recurring intervals to track the classification of the customer service site over time, wherein the two or more classification types comprise service types including at least two of residential, commercial, industrial, hospitality, governmental, or agricultural; and
responsive to the tracking indicating a change in the classification of the customer service site, adjusting operation of the component of the electricity grid.

23. The method of claim 1, wherein the two or more classification types include a classification type indicative of a suspected criminal enterprise.

24. The method of claim 1, wherein determining the classification comprises calculating a Dynamic Time Warping distance between the load data and load patterns associated with each of the two or more classification types.
